(19) United States
(12) Patent Application Publication
(10) Pub. No.: US 2014/0289288 A1
(43) Pub. Date: Sep. 25, 2014

(54) RELAY APPARATUS, SYSTEM, AND NON-TRANSITORY COMPUTER READABLE MEDIUM

(71) Applicant: FUJI XEROX CO., LTD., Tokyo (JP)

(72) Inventor: Shigeki ISHINO, Kanagawa (JP)

(73) Assignee: FUJI XEROX CO., LTD., Tokyo (JP)

(21) Appl. No.: 14/060,189

(22) Filed: Oct. 22, 2013

(30) Foreign Application Priority Data
Mar. 21, 2013 (JP) 2013-057922

(51) Int. Cl. G06F 17/30

(52) U.S. Cl. CPC G06F 17/30194
USPC 707/827

(57) ABSTRACT

A relay apparatus includes a receiving unit, a downloading unit, and an uploading unit. The receiving unit receives a file operation request from a client apparatus. The file operation request includes storage source information identifying a file stored in a storage area of a first server apparatus providing a cloud service with a storage location of the file, storage destination information identifying one storage location included in a storage area of a second server apparatus providing a cloud service, and operation type information instructing copy or movement of the file. The downloading unit downloads the file identified by the storage source information from the storage location identified by the storage source information. The uploading unit uploads the downloaded file to the storage area identified by the storage destination information included in the received file operation request without transmitting the downloaded file to the client apparatus.

### CROSS-REFERENCE TO RELATED APPLICATIONS

This application is based on and claims priority under 35 USC 119 from Japanese Patent Application No. 2013-057922 filed Mar. 21, 2013.

### BACKGROUND

(i) Technical Field

The present invention relates to a relay apparatus, a system, and a non-transitory computer readable medium.

(ii) Related Art

Services called cloud services or cloud computing are known. In such a service, for example, a server apparatus on a network performs a variety of information processing including storage of data and conversion of a data format on behalf of a client apparatus.

### SUMMARY

According to an aspect of the invention, there is provided a relay apparatus including a receiving unit, a downloading unit, and an uploading unit. The receiving unit receives a file operation request from a client apparatus. The file operation request includes storage source information identifying a file stored in a storage area of a first server apparatus providing a cloud service with a storage location of the file, storage destination information, identifying one storage location included in a storage area of a second server apparatus providing a cloud service, and operation type information instructing copy or movement of the file. The downloading unit downloads the file identified by the storage source information included in the file operation request received by the receiving unit from the storage location identified by the storage source information, fee uploading unit uploads the file downloaded by one downloading unit to the storage area identified by the storage destination information included in the file operation request received by the receiving unit without transmitting the file downloaded by the downloading unit to the client apparatus, which has transmitted the file operation request received by the receiving unit.

### BRIEF DESCRIPTION OF THE DRAWINGS

Exemplary embodiments of the present invention will be described in detail based on the following figures, wherein:

FIG. 1 is a block diagram illustrating an example of the entire configuration of a communication system according to an exemplary embodiment;

FIG. 2 illustrates an exemplary hardware configuration of a cloud service providing apparatus;

FIG. 3 illustrates an exemplary hardware configuration of an image processing apparatus;

FIG. 4 illustrates an exemplary hardware configuration of a relay apparatus;

FIG. 5 illustrates an exemplary functional configuration of the communication system;

FIG. 6 is a sequence chart illustrating a copy process;

FIG. 7 illustrates an exemplary screen for selecting a file;

FIG. 3 illustrates an exemplary screen for specifying a storage area to which the file is to be copied;

FIG. 9 illustrates an example of a copy completion screen;

FIG. 10 is a sequence chart illustrating a movement process;

FIG. 11 illustrates an exemplary screen for specifying a storage area to which the file is to be moved;

FIG. 12 illustrates an example of a movement completion screen; and

FIG. 13 is a block diagram illustrating an example of the entire configuration of a communication system according to a modification.

### DETAILED DESCRIPTION

### [Configuration]

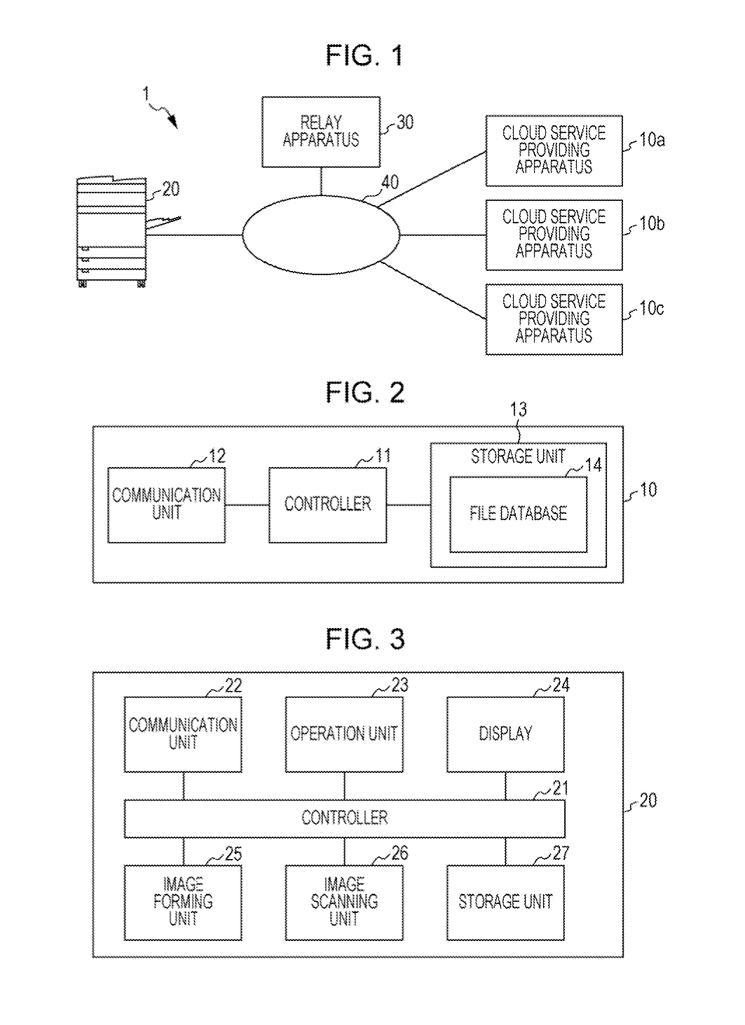

FIG. 1 is a block diagram illustrating an example of the entire configuration of a communication system 1 according to an exemplary embodiment of the present invention. Referring to FIG. 1, the communication system 1 includes cloud, service providing apparatuses 10a, 10b, and 10c, an image processing apparatus 20, and a relay apparatus 30. The cloud service providing apparatuses 10a, 10b, and 10c provide the so-called cloud, services. In the cloud service, server apparatuses on a network perform a variety of information processing including storage and provision of data. The image processing apparatus 20 receives the services provided by the cloud service providing apparatuses 10a, 10b, and 10c. In the present exemplary embodiment, the image processing apparatus 20 has a print function and a scanning function. The image processing apparatus 20, the relay apparatus 30, and the cloud service providing apparatuses 10a, 10b, and 10c are connected to each other via a network 40. The network 40 is, for example, the Internet.

The relay apparatus 30 relays data exchanged between the cloud service providing apparatuses 10a, 10b, and 10c and the image processing apparatus 20 in the provision of the services from the cloud service providing apparatuses 10a, 10b, and 10c to the image processing apparatus 20. Specifically, upon reception of data to be stored from the image processing apparatus 20, the relay apparatus 30 transfers the data to any or some of the cloud service providing apparatuses 10a, 10b, and 10c. Upon reception of data to be printed from any of the cloud service providing apparatuses 10a, 10b, and 10c, the relay apparatus 30 transfers the data to the image processing apparatus 20. In addition, in transmission and reception of the above pieces of data between the cloud service providing apparatuses 10a, 10b, and 10c and the image processing apparatus 20, the relay apparatus 30 may invoke a service other than the transmission and the reception (for example, data processing, such as a character recognition service called optical character recognition (OCR) or a service to convert a data format) to cause the service to perform the processing to the data.

Since the cloud service providing apparatuses 10a, 10b, and 10c have the same hardware configuration and perform the same operation, the cloud service providing apparatuses 10a, 10b, and 10c are collectively referred to as a cloud service providing apparatus 10 unless they are distinguished from each other.

FIG. 2 illustrates an exemplary hardware configuration of the cloud service providing apparatus 10. Referring to FIG. 2, the cloud service providing apparatus 10 includes a controller 11, a communication unit 12, and a storage unit 13. The controller 11 includes an arithmetic device, such as a central processing unit (CPU), and main memories including a read only memory (ROM) and a random access memory (RAM). The arithmetic device executes a program stored in the ROM or the storage unit 13 by using the RAM as a working area to control the operations of the components in the cloud service providing apparatus 10. The communication unit 12 communicates with the relay apparatus 30 via the network 40. The storage unit 13 is a storage device, such as a hard disk, and stores data and programs used by the controller 11. The storage unit 13 stores a file database 14 (an example of a first storage area and a second storage area). Files transmitted from the image processing apparatus 20 via the relay apparatus 30 are accumulated in the file database 14. in the present exemplary embodiment, the “file” is used as a term to represent data representing the content of various documents and images. The data includes document data representing a document and image data representing an image. The “file” may be a computer program and a collection of pieces of data is called the “file.”

FIG. 3 illustrates an exemplary hardware configuration of the image processing apparatus 20. Referring to FIG. 3, the image processing apparatus 20 includes a controller 21, a communication unit 22, an operation unit 23, a display 24, an image forming unit 25, an image scanning unit 26, and a storage unit 27. The controller 21 includes an arithmetic device, such as a CPU, and main memories including a ROM and a RAM. Programs executed by the arithmetic device are stored in the ROM. The arithmetic device executes a program stored in the ROM or the storage unit 27 by using the RAM as the working area to control the operations of the components in the image processing apparatus 20. The communication unit 22 communicates with the relay apparatus 30 via the network 40. The operation unit 23 includes operators including various keys and a touch sensor and supplies an operation signal corresponding to an operation by a user to the controller 21. The controller 21 performs processing corresponding to the operation signal. The display 24 includes a liquid crystal panel and a liquid crystal drive circuit, and displays an image under the control of the controller 21. The image forming unit 25 electrophotographically forms an image. The image scanning unit 26 optically scans an image of a document. The storage unit 27 is a storage device, such as a hard disk, and stores data and programs used by the controller 21.

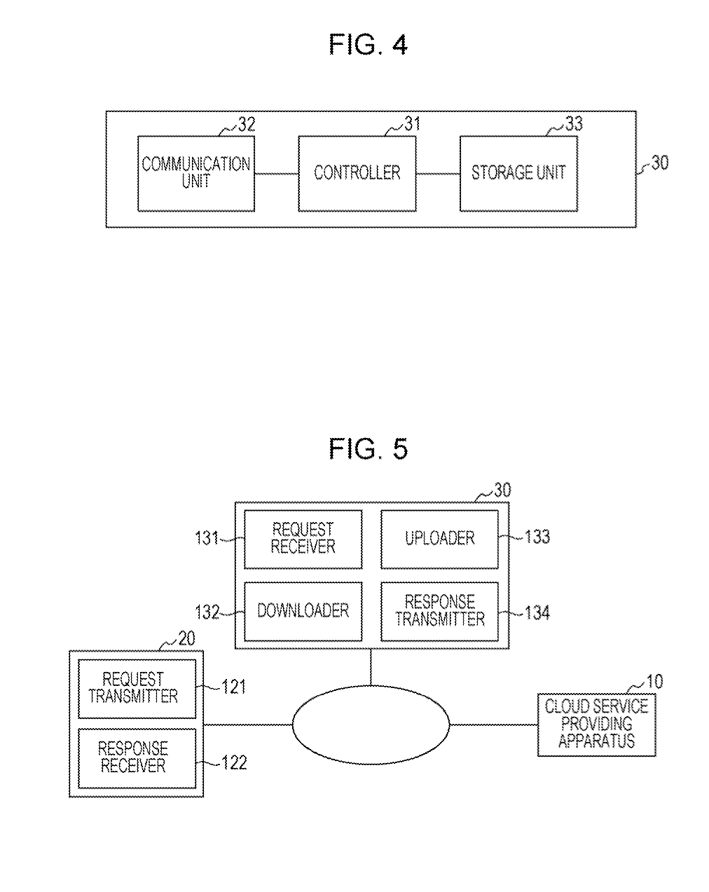

FIG. 4 illustrates an exemplary hardware configuration of the relay apparatus 30. Referring to FIG. 4, the relay apparatus 30 includes a controller 31, a communication unit 32, and a storage unit 33. The controller 31 includes an arithmetic device, such as a CPU, and main memories including a ROM and a RAM. The arithmetic device executes a program stored in the ROM or the storage unit 33 by using the RAM as the working area to control the operations of the components in the relay apparatus 30. The communication unit 22 communicates with the image processing apparatus 20 and the cloud service providing apparatus 10 via the network 40. The storage unit 33 is a storage device, such as a hard disk, and stores data and programs used by the controller 31.

FIG. 5 illustrates an exemplary functional configuration of the communication system 1. The image processing apparatus 20 realizes the functions of a request transmitter 121 and a response receiver 122 with the controller 21 or the controller 21 and the communication unit 22. The request transmitter 121 generates a request (fire operation information) instructing an operation of a file, such as copy (replication) or movement of the file, in response to an operation by the user to transmit the generated request to the relay apparatus 30.

The request generated by the request transmitter 121 includes “operation type information”, “storage source information”, and “storage destination information.” The “operation type information” indicates the type of an operation for a file, such as “copy”, “movement”, “deletion”, or “printout.” The “storage source information” identifies a file to be operated along with the storage location of the file to be operated and is, for example, a uniform resource identifier (URI). The “storage destination information” identifies one storage location included in the storage area of the cloud service providing apparatus 10. The “storage destination information” is included in the request when the “operation type information” indicates an operation, such as the “copy” or the “movement”, which requires information indicating the storage destination. In other words, the “storage destination information” is not included in the request when the “operation type information” indicates an operation (for example, the deletion of the file) which does not require the information indicating the storage destination.

The response receiver 122 receives a response transmitted from the relay apparatus 30 as a reply of the request which the request transmitter 121 has transmitted. The response received by the response receiver 122 includes information indicating whether the file operation succeeds. The response receiver 122 displays the result of the file operation indicated by the received response in the display 24.

The relay apparatus 30 realizes the functions of a request receiver 131, a downloaded 132, an uploader 133, and a response transmitter 134 with the controller 31 or the controller 31 and the communication unit 32. The request receiver 131 receives a request transmitted from the image processing apparatus 20.

The downloader 132 downloads a target file from the cloud service providing apparatus 10 when the request received by the request receiver 131 instructs the movement or the copy of the file. Specifically, the downloaded 132 transmits a request indicating that the file identified by the storage source information included in the received request is to be downloaded to the cloud service providing apparatus 10 corresponding to the storage source information.

In the present exemplary embodiment, the multiple cloud service providing apparatuses 10a, 10b, and 10c transmit and receive data in accordance with different communication protocols or different data input-output formats. Accordingly, the downloader 132 transmits and receives data conforming to the communication protocol or the data input-output format which the cloud service providing apparatus 10 where the target file is stored uses in the provision of the cloud service to and from the cloud service providing apparatus 10 to download the file.

The uploader 133 uploads the file downloaded by the downloader 132 to the storage area identified by the storage destination information included in the request received by the request receiver 131. The uploader 133 transmits and receives data conforming to the communication protocol or the data input-output format which the cloud service providing apparatus 10 corresponding to the target storage area uses in the provision of the cloud service to and from the cloud service providing apparatus 10 to upload the file.

The response transmitter 134 transmits a response (completion information) indicating completion of the uploading to the image processing apparatus 20, which has transmitted the request received by the request receiver 131, upon completion of the uploading of the file by the uploader 133.

### [Operations]

### (Copy Process)

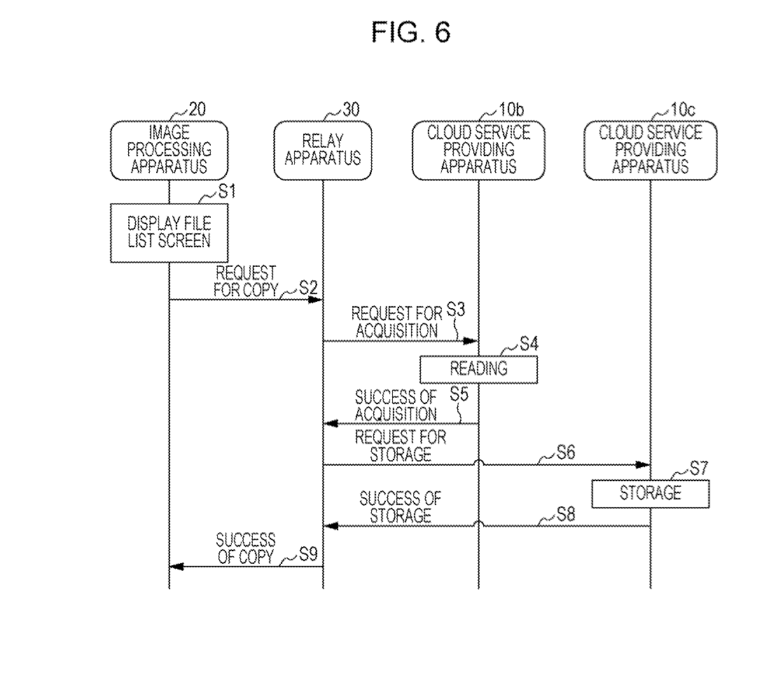

Exemplary operations according to exemplary embodiments will now be described. First, a process of copying a file stored in the cloud service providing apparatus 10b to the cloud service providing apparatus 10c will be described with reference to a sequence chart illustrated in FIG. 6. The cloud services provided by the cloud service providing apparatuses 10a, 10b, and 10c are hereinafter referred to as a “cloud service A”, a “cloud service B”, and a “cloud service C”, respectively.

Referring to FIG. 6, a user U operates the operation unit 23 to instruct display of a file list stored in the cloud service B. The controller 21 inquires of the cloud service providing apparatus 10b in accordance with the information output from the operation unit 23 to acquire information indicating the file list from the cloud service providing apparatus 10b. The storage source information (for example, the URIs) indicating the locations where the files are stored is included in this information. Upon acquisition of the information indicating the file list, in Step S1, the controller 21 displays a file list screen in the display 24 in accordance with the acquired information.

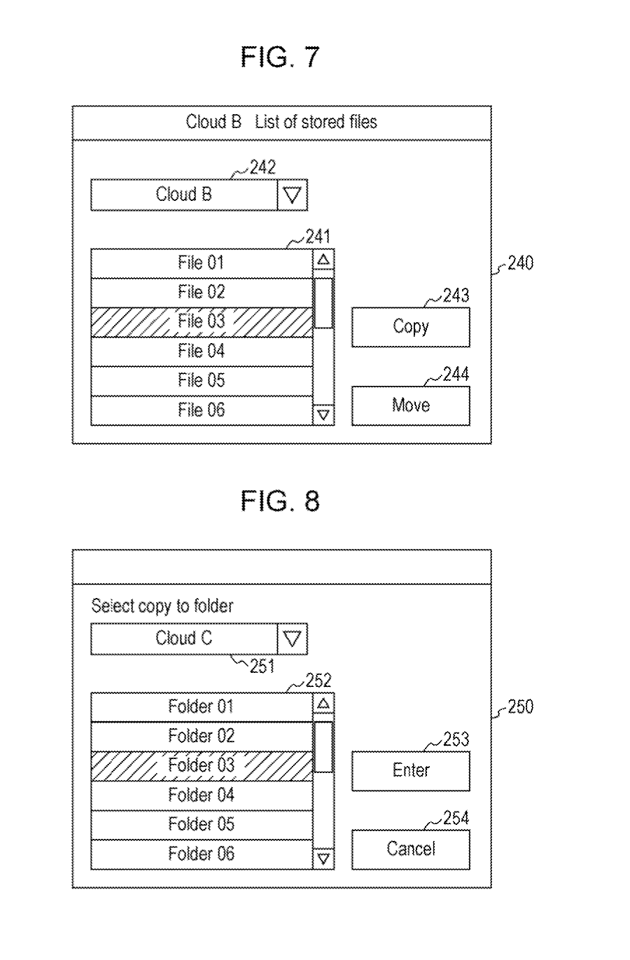

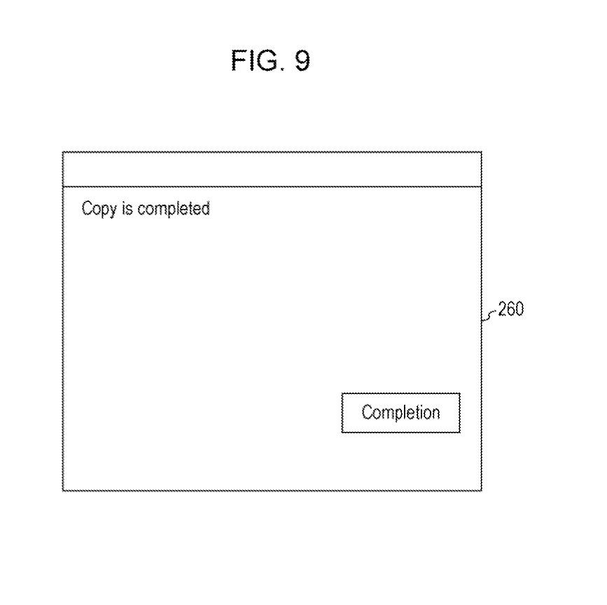

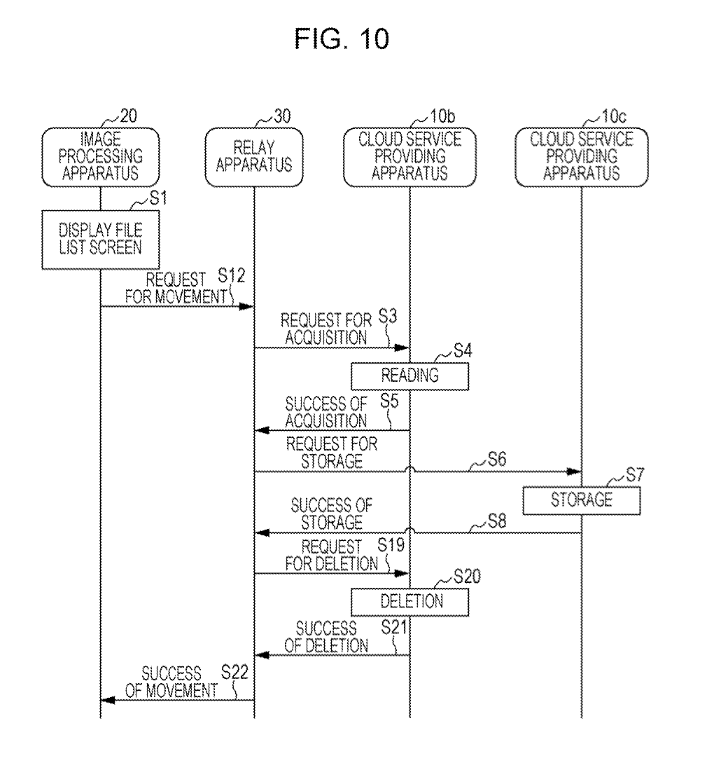

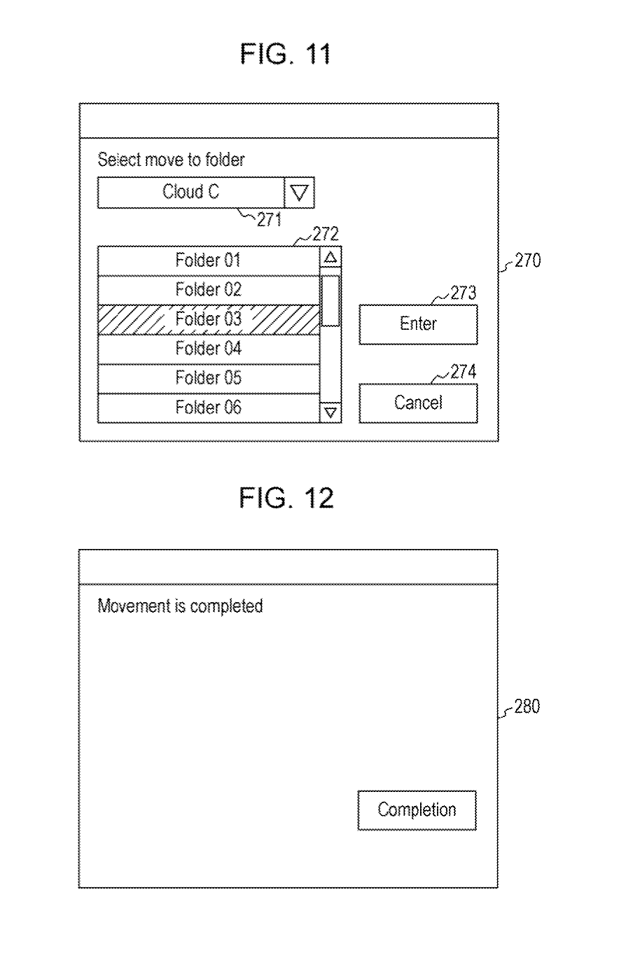

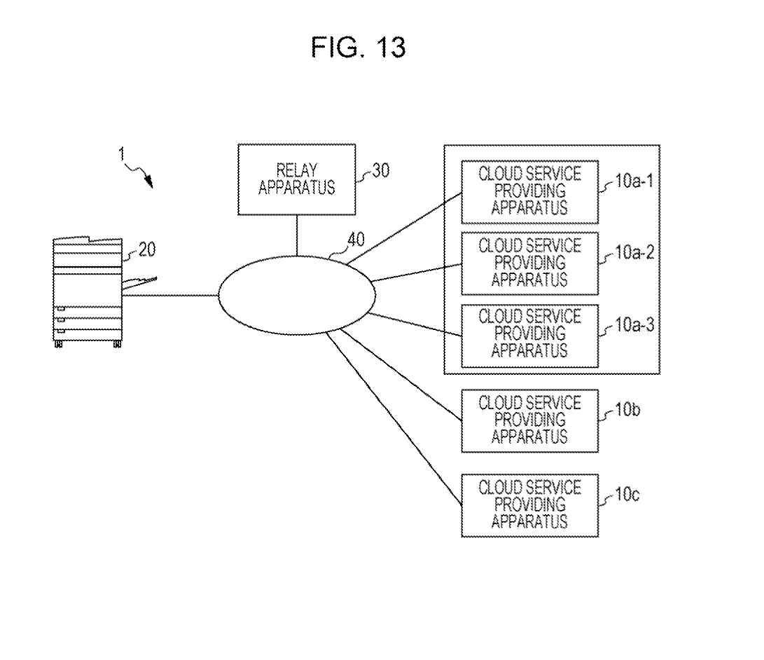

FIG. 7 illustrates an example of the file list screen. In the example illustrated in FIG. 1, a list box 242 used for selecting a cloud service, a file list 241 of files stored in the cloud service selected with the list box 242, a Copy button 243 for instructing copy of a file, and a Move button 244 for instructing movement of a file are displayed on a list screen 240. Upon display of the list screen 240, the user U operates the operation unit 23 to select any of the multiple cloud services with the list box 242 and select any of the files displayed in the file list 241 and presses the Copy button 243. Upon depression of the Copy button 243, the controller 21 displays a screen for selecting a folder to which the file is to be copied in the display 24.

FIG. 8 illustrates an example of the screen for selecting a folder to which the file is to be copied. In the example illustrated in FIG. 8, a list box 251 for selecting a cloud service to which the file is to be copied, a folder list 252 of the cloud service selected with the list box 251, an Enter button 253 for instructing determination, and a Cancel button 254 for instructing cancel are displayed on a screen 250. Upon display of the screen 250, the user U operates the operation unit 23 to select a cloud service to which the file is to be copied from, the multiple cloud services with the list box 251 and select any of the folders displayed in the folder list 252 and presses the Enter button 253.

Referring back to FIG. 6, upon depression of the Enter button 253, in Step S2, the controller 21 generates a request (replication request) to instruct the copy of the selected file in accordance with the operation by the user to transmit the generated request to the relay apparatus 30. The operation type information indicating the copy, the storage source information about the selected file, and the storage destination information to which the file is to be stored are included in the request. A case is descried in this exemplary operation in which, a folder in the cloud service C is selected as the storage destination of the file.

In Step S3, upon reception of the request from the image processing apparatus 20, the controller 31 in the relay apparatus 30 determines the type of the file operation information included in the request and, if the received request instructs the copy of the file, transmits a request to acquire the target file to the cloud service providing apparatus 10b. In Step S4, the cloud service providing apparatus 10b receives the request transmitted from the relay apparatus 30 and reads out the file in accordance with the received request. In Step S5, the cloud service providing apparatus 10b transmits the file that is read out to the relay apparatus 30 as a reply to the received request.

In Step S6, upon reception of the file from the cloud service providing apparatus 10b, of the controller 31 in the relay apparatus 30 transmits the received file to the cloud service providing apparatus 10c without transmitting the received file to the image processing apparatus 20 to instruct the cloud service providing apparatus 10c to store the file. The storage destination information indicating the storage destination of the file is included in the instruction. In Step S7, upon reception of the file from the relay apparatus 30, the cloud service providing apparatus 10c stores the received file in the storage area indicated by the storage destination information included in the receive instruction. In Step S8, the cloud service providing apparatus 10c transmits a response indicating completion of the storage to the relay apparatus 30 as a reply to the request received in Step S6.

In Step S9, upon reception of the response from the cloud service providing apparatus 10c, the controller 31 in the relay apparatus 30 transmits a response indicating the completion of the copy to the image processing apparatus 20 as a reply to the request received in Step 32. Upon reception of the response from the relay apparatus 30, the controller 21 in the image processing apparatus 20 displays a screen 260 for indicating the completion of the copy to the user U, illustrated in FIG. 9, in the display 24.

### (Movement Process)

Next, a process of moving a file stored in the cloud service providing apparatus 10b to the cloud service providing apparatus 10c will be described with reference to a sequence chart illustrated in FIG. 10. The same step numbers are used in FIG. 10 to identify the same steps illustrated in FIG. 6. A description of such steps is appropriately omitted herein.

Referring to FIG. 10, the user U operates the operation unit 23 to instruct display of the file list stored in the cloud service 8. The controller 21 inquires of the cloud service providing apparatus 10b in accordance with the information output from the operation unit 23 to acquire information indicating the file list from the cloud service providing apparatus 10b. The storage source information (for example, the URIs) indicating the locations where the files are stored is included in this information. Upon acquisition, of the information indicating the file list, in Step S1, the controller 21 displays the file list screen illustrated in FIG. 7 in the display 24 in accordance with, the acquired information. The display step is the same as the one described above in Step S1 in FIG. 6.

Upon display of the list screen 240 illustrated in FIG. 7, the user U operates the operation unit 23 to select any of the multiple cloud services with the list box 242 and select, any of the tiles displayed in the file list 241 and presses the Move button 244. Upon depression of the Move button 244, the controller 21 displays a screen for selecting a folder to which the file is to be moved in the display 24.

FIG. 11 illustrates an exemplary screen for selecting a folder to which the file is to be moved. In the example illustrated in FIG. 11, a list box 271 for selecting a cloud service to which the file is to be moved, a folder list 272 of the cloud service selected with the list box 271, an Enter button 273 for instructing determination, and a Cancel button 274 for instructing cancel are displayed on a screen 270. Upon display of the screen 270, the user U operates the operation unit 23 to select a cloud service to which the file is to be moved from the multiple cloud services with the list box 271 and select any of the folders displayed in the folder list 272 and presses the Enter button 273.

Referring back to FIG. 10, upon depression of the Enter button 273, in Step S12, the controller 21 generates a request (movement request) to instruct the movement of the selected file in accordance with the operation by the user to transmit the generated request to the relay apparatus 30. The operation type information indicating the movement, the storage source information about the selected file, and the storage destination information to which the file is to be moved are included in the request. A case is described in this exemplary operation in which a folder in the cloud service C is selected as the storage destination of the file.

In Step S3, upon reception of the request from the image processing apparatus 20, the controller 31 in the relay apparatus 30 determines the type of the file operation information included in the request and, if the received request instructs the movement of the file, transmits a request to acquire the target file to the cloud service providing apparatus 10b. As in the copy process described above, the processing in Steps S4 to S8 is performed by the relay apparatus 30, the cloud service providing apparatus 10b, and the cloud service providing apparatus 10c to move the file stored in the cloud service providing apparatus 10b to the cloud service providing apparatus 10c. The processing in Steps S3 to S8 are the same as the one illustrated in FIG. 6.

Upon reception of the response indicating the completion of the storage from the cloud service providing apparatus 10c in Step S8, in Step S19, the controller 31 in the relay apparatus 30 transmits a request to instruct deletion of the file to the cloud service providing apparatus 10b. The storage source information indicating the location where the file is stored is included in the request. In Step S20, upon reception of the request from the relay apparatus 30, the cloud service providing apparatus 10b deletes the specified file from the storage area. Upon completion of the deletion, in Step S21, the cloud service providing apparatus 10b transmits a response indicating the completion of the deletion to the relay apparatus 30 as a reply to the request received in Step S19. In Step S22, upon reception of the response from the cloud service providing apparatus 10b, the controller 31 in the relay apparatus 30 transmits a response indicating the completion of the movement to the image processing apparatus 20 as a reply to the request received in Step S2. Upon reception of the response from the relay apparatus 30, the controller 21 in the image processing apparatus 20 displays a screen 280 for indicating the completion of the movement to the user U, illustrated in FIG. 12, in the display 24.

In the above exemplary embodiments, when one copy or the movement of a file is performed over the multiple cloud services, the copy or the movement is performed via the relay apparatus 30 without temporarily downloading the file to the image processing apparatus 20. Accordingly, the amount of traffic between the image processing apparatus 20 and the cloud service providing apparatus 10 is reduced.

### [Modifications]

The exemplary embodiments described above are only examples and the following modifications may be made. Combinations of the modifications described below may be adopted.

(1) Although the copy or the movement of a file between the cloud services when different communication protocols or different data input-output formats are used in the communication between different cloud services and the relay apparatus is described in the above exemplary embodiments, the copy or the movement may be performed with tag data or attribute data added to the file data, in addition to the copy or the movement of only the file data. Specifically, when the relay apparatus receives a file stored in the cloud service A and stores the file in the cloud, service B to perform the copy of the file, the controller 31 in the relay apparatus 30 may receive the file, the tag format added to the file, and the value of the tag format from the cloud service A on the basis of the communication protocol or the data input-output format with the cloud service A, may convert the received file, the tag format added to the received file, and the value of the tag format on the basis of the communication protocol or the data input-output format with the cloud service B, and may transmit the file, the tag format added to the file, and the value of the tag format to the cloud service B for storage.

(2) Although the case is described in the above exemplary embodiments in which the operation type information, the storage source information, and the storage destination information are included in the request transmitted from the image processing apparatus 20, the pieces of information included in the request are not limited to the above ones and other information may be included in the request.

(3) The configuration of the communication system 1 is not limited to the one described in the above exemplary embodiments. For example, the number of the apparatuses composing the communication system 1 may be different from the one described in the exemplary embodiments. For example, although the example is described in the above exemplary embodiments in which the communication system 1 includes one image processing apparatus 20, one image processing apparatus 20 may not be limitedly used and multiple image processing apparatuses may be used. Although one cloud service providing apparatus 10 provides one cloud service in the above exemplary embodiments, one cloud service may be provided by multiple server apparatuses. Specifically, for example, as illustrated in FIG. 13, one cloud service may be provided by multiple cloud service providing apparatuses 10a-1, 10a-2, and 10a-3.

Although the example is described in the above exemplary embodiments in which the three cloud services are provided, the number of the cloud services is not limited to three and the cloud service of a number larger than or smaller than three may be provided.

(4) Although the controller 31 in the relay apparatus 30 notifies the image processing apparatus 20 of the completion of the copy or the movement (Step S9 in FIG. 6 or Step S22 in FIG. 10) in the above exemplary embodiments, the notification may not be performed. Alternatively, the controller 31 may transmit information indicating the progress of the copy process or the movement process to the image processing apparatus 20 at predetermined timing.

(5) Although the controller 21 in the image processing apparatus 20 specifies one folder as the destination to which a file is to be copied in the above exemplary embodiments, the destination to which the file is to be copied is not limited to one storage area and the file may be copied to multiple storage areas. In this case, the controller 21 may generate a request including multiple pieces of storage destination information in accordance with the content of the operation by the user to transmit the request to the relay apparatus 30. Upon reception of the request, the controller 31 in the relay apparatus 30 may transmit a request to instruct the storage to the cloud service providing apparatuses 10 including the storage areas indicated by the multiple pieces of the storage destination information included in the received request.

(6) The image processing apparatus 20 described in the above exemplary embodiments is an example of a client apparatus that receives the provision of the service from the cloud service providing apparatus 10. The client apparatus may be another apparatus, such as a personal computer (PC), a tablet PC, or a mobile phone.

(7) The programs executed by the image processing apparatus 20 and the relay apparatus 30 may be downloaded via a communication line, such as the Internet. Alternatively, the programs may be provided in a state in which the programs are recorded on a computer-readable recording medium, such as a magnetic recording medium (for example, a magnetic tape or a magnetic disk), an optical recording medium (for example, an optical disk), a magneto-optical recording medium, or a semiconductor memory.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A relay apparatus comprising:
a receiving unit that, receives a file operation request from a client apparatus, the file operation request including storage source information identifying a file stored in a storage area of a first server apparatus providing a cloud service with a storage location of the file, storage destination information identifying one storage location included in a storage area of a second server apparatus providing a cloud service, and operation type information instructing copy or movement of the file;
a downloading unit that downloads the file identified by the storage source information included in the file operation request received by the receiving unit from the storage location identified by the storage source information; and
an uploading unit that uploads the file downloaded by the downloading unit to the storage area identified by the storage destination information included in the file operation request received by the receiving unit without transmitting the file downloaded by the downloading unit to the client apparatus, which has transmitted the file operation request received by the receiving unit.

2. The relay apparatus according to claim 1,
wherein the downloading unit transmits and receives data conforming to a protocol, used by the first server apparatus in the provision of the cloud service to and from the first server apparatus to perform the downloading, and
wherein the uploading unit transmits and receives data conforming to a protocol used by the second server apparatus in the provision of the cloud, service to and from the second server apparatus to perform the uploading.

3. The relay apparatus according to claim 1, further comprising:
a completion information transmitting unit that, upon completion of the uploading of the file by the uploading unit, transmits completion information indicating completion of the uploading to the client apparatus that has transmitted the file operation request received by the receiving unit.

4. The relay apparatus according to claim 2, further comprising:
a completion information transmitting unit that, upon completion of the uploading of the file by the uploading unit, transmits completion information indicating completion of the uploading to the client apparatus that has transmitted the file operation request received by the receiving unit.

5. A system comprising:
a client apparatus; and
a relay apparatus,
wherein the client apparatus includes
a transmitting unit that transmits file operation information to the relay apparatus, the file operation information at least including storage source information that is provided by a first service and that indicates a file stored in a first storage area and storage destination information that is provided by a second service and that indicates a second storage area, the file operation information instructing copy or movement of the file, and
wherein the relay apparatus includes
a receiving unit that receives a file operation request from the client apparatus, the file operation request including storage source information identifying a file stored in a storage area of a first server apparatus providing a cloud service with a storage location of the file, storage destination information identifying one storage location included in a storage area of a second server apparatus providing a cloud service, and operation type information instructing copy or movement of the file;
a downloading unit that downloads the file identified by the storage source information included in the file operation request received by the receiving unit from the storage location identified by the storage source information; and
an uploading unit that uploads the file downloaded by the downloading unit to she storage area identified by the storage destination information included in the file operation request received by the receiving unit without transmitting the file downloaded by the downloading unit to the client apparatus, which has transmitted the file operation request received by the receiving unit.

6. A non-transitory computer readable medium storing a program causing a computer to execute a process comprising:
receiving a file operation request from a client apparatus, the file operation request including storage source information identifying a file stored in a storage area of a first server apparatus providing a cloud service with a storage location of the file, storage destination information identifying one storage location included in a storage area of a second server apparatus providing a cloud service, and operation type information instructing copy or movement of the file;
downloading the file identified by the storage source information included in the received file operation request from the storage location identified by the storage source information; and
uploading the downloaded file to the storage area identified by the storage destination information included in the received file operation request without transmitting the downloaded file to one client apparatus, which has transmitted the received file operation request.

7. A relay method comprising:
receiving a file operation request from a client apparatus, the file operation request including storage source information identifying a file stored in a storage area of a first server apparatus providing a cloud service with a storage location of the file, storage destination information identifying one storage location included in a storage area of a second server apparatus providing a cloud service, and operation type information instructing copy or movement of the file;
downloading the file identified by the storage source information included in the received file operation request from the storage location identified by the storage source information; and
uploading the downloaded file to the storage area identified by the storage destination information included in the received file operation request without transmitting the downloaded file to the client apparatus, which has transmitted the received file operation request.
